(19) United States
(12) Patent Application Publication
(10) Pub. No.: US 2018/0342170 A1
(43) Pub. Date: Nov. 29, 2018

(54) Math game and method

(71) Applicant: Edwin De Jesus Molina Munoz, Cartagena (CO)

(72) Inventor: Edwin De Jesus Molina Munoz, Cartagena (CO)

(21) Appl. No.: 15/932,926

(22) Filed: May 24, 2018

(30) Foreign Application Priority Data
May 24, 2017 (CO) 10-644-78

(51) Int. Cl. G09B 1/34; A63F 9/20; A63F 3/04; G09B 19/22; G09B 19/02

(52) U.S. Cl. CPC G09B 1/34; A63F 9/20; G09B 19/02; G09B 19/22; A63F 3/0415

(57) ABSTRACT

A dominoes-style mathematical operation game is provided including, but not limited to, a plurality of dominoes, each domino having a top face in the bottom face. The bottom face of each domino has a pair of equally sized sides each with unique combination of an at least a number indicia and a mathematical sign and possibly a physical representation of at least one of addition, subtraction, division, multiplication, equality, calculus operations, comparison, and algebraic equations.

### BACKGROUND OF THE DISCLOSURE

The present disclosure is directed, in general, to providing and introducing a learning system and method, such as, for example, a board game, similar to dominoes, in the school classroom, at home, and other locations compatible for family play and interaction, for the use of the traditional dominos game, combined with basic mathematical operations, in order to facilitate student learning of different levels of mathematics and essential concepts according to the specific learning level of each individual student.

The present disclosure is also directed to reducing the difficulty learning and teaching the mathematical sciences, which due to its abstract nature and form, represents one of the areas that most often results in school failure at all levels of education; Math is the area that typically receives the lowest marks in school subject matter classroom teaching evaluations.

The present disclosure is further directed to developing an effective educational teaching technique and/or system and method, that facilitates student learning basic and higher-level mathematical concepts, which are then internalized by the students through the repetitive action of the operations that arise and the interaction between the students playing a Math Game, as disclosed in the present disclosure, and learning faster, easier and enjoyable by, making the experience something fun, educationally enjoyable and resulting in profitable educational outcomes for both students and teacher.

A number of prior art references directed to dominoes-style mathematical operation games are disclosed in the following U.S. Pat. Nos. 5,114,344; 6,062,566; 7,604,237; and; 7,857,315, each of which are herein incorporated by reference to the extent not inconsistent with the present disclosure. While some of these issued patents describe methods for improving one's math skills, while being entertaining and eye pleasing, they fail to disclose or teach the highest level of learning and improving math skills utilizing a dominoes-style mathematical operation game.

In an effort to increase the attention level and learning achievements of the students during one of the inventors mathematics classes after a class when the students had failed to pay attention to the lesson being taught in the math class that day, the inventor of the present application visited a hardware store where he bought a sheet of triplex wood and cut the sheet into 28 pieces the size of a traditional domino and divided each of the 28 pieces into two parts and marked each with the numerals 1-6 points, or none, along with math operations that are part at the sixth grade school math level, in such a way that each result of the operations raised coincided with the numbers of the traditional dominoes and the Math Game and Method of the present disclosure was developed with virtually the same rules of the 28 pieces in the traditional dominoes game.

As used in this disclosure, the term Mathematics, is the science that studies the relationships between quantities magnitudes and properties, and the logical operations used to compute quantities, magnitudes and known or unknown properties.

As used in this disclosure, The term Learning is an acquisition of knowledge of something to study, or experience, especially knowledge necessary to learn some art or skilled trade.

As used in this disclosure, the term Learning Method, is a set of strategies designed to create an environment of harmony in students immersed in the learning process. This method takes the appropriate topics taught by teachers using the Math Game and Method of the present disclosure.

As used in this disclosure, the term Strategic Thinking, includes, but is not limited to, the adaptation capacity that the player will develop through the selective use of what has been learned to win the game, as disclosed in the present disclosure.

As used in this disclosure, the term educational methodology includes innovation in the way of imparting the knowledge of mathematics through repetitive action in the play of the Math Game and Method taught by the present disclosure.

As used in this disclosure, the term Game Models, is directed to the different levels of schooling difficulty, to date six levels, as presently are disclosed and taught by the present disclosure.

As is well known, Mathematics is an essential instrument of scientific knowledge. Due to its abstract nature and form, its learning is difficult for a large number of students from the elementary level to college-level and mathematics is the subject that most affects school failure at all levels of education; mathematics is the area that test results are the most negative results in nearly every school test evaluation.

It is anticipated that the subject matter of the present disclosure will be utilized to introduce a playful learning tool into the classroom and at home for family play and interaction, from the use of the traditional domino game, combined with basic mathematical operations, in order to consolidate learning of mathematics essential concepts, according to the specific learning level of each student.

It is also anticipated that the application and repeated use of this innovative, valuable and playful tool, the student manages to consolidate the learning of basic mathematical concepts according to each level of school learning in a fun and entertaining way, accompanied by classmates, teachers, parents and relatives.

It is further anticipated that, in the classroom, properly chosen and dosed games offer a new learning opportunity, and generate an emotional and affective context conducive to the development of mathematical learning and ideas. Utilizing the principals of the present innovation, mathematical reasoning is promoted in a natural and motivating way, and subtly leads students to investigate new math learning techniques in order for the student to learn proper techniques to solve problems, and develops specific skills of strategic thinking, planning, decision-making, estimation and demonstration. Likewise, when students play, their level of anxiety decreases, communication between student's increases, interest in Math grows and concentration increases. Additionally, the playful interaction facilitates the teacher's task of measuring the degree of understanding of the math concepts, the ability to put the learned concepts and certain knowledge into practice, including the increased ability of the students to communicate ideas and argue proposals.

Games and mathematics have many features in common when it comes to their educational purpose. Mathematics equips students with a set of skills that enhance and enrich their mental structures, and enable them to explore and act in reality. Traditional games teach schoolchildren to take the first steps in the development of intellectual techniques, enhance logical thinking, develop reasoning habits, and teach thinking with a critical spirit.

The games, by the mental activity they generate, are a good starting point for the teaching of mathematics, and create the basis for a later formalization of mathematical thought.

The best method to keep awake a student is to propose an intriguing mathematical game, a hobby, a magic trick, a joke, a paradox, a model, a tongue twister or anything that has fun.

The fundamental objective is to assist students to better develop their mind and their intellectual, sensitive, affective, physical potentials in a harmonious way. In addition, for this our main instrument must consist of the stimulation of its own action, placing it in situations that encourage the exercise of those activities that can lead to the acquisition of the most characteristic basic attitudes that are intended to be transmitted with the cultivation of each subject.

Through the application and repeated use of this valuable playful tool, the student manages to consolidate basic mathematical concepts according to each level of schooling, in a fun and entertaining way, accompanied by his classmates, teachers, parents and relatives. For this reason, a folder of basic instructions is prepared, which serves as a guide for students, teachers and parents interested in actively participating in the academic development of their children through the game.

In the classroom, properly chosen and dosed games offer a new learning opportunity, and generate an emotional and affective context conducive to the development of mathematical learning and ideas. Utilizing the principals of the present innovation, mathematical reasoning is promoted in a natural and motivating way, and subtly leads students to investigate new math learning techniques in order for the student to learn proper techniques to solve problems, and develop specific skills, such as, for example, strategic thinking, planning, decision-making, estimation and demonstration. Likewise, when students play, their level of anxiety decreases, communication between student's increases, interest in Math grows and concentration increases. Additionally, the playful interaction facilitates the teacher's task of measuring the degree of understanding of the math concepts, the ability to put the learned concepts and certain knowledge into practice, including the increased ability of the students to communicate ideas and argue proposals.

As discussed above, at all educational levels, games can advantageously replace some passive routine tasks with more active student participation learning processes and experiences. Hence, the value of systematically including the present innovative learning method in a Mathematics learning program can achieve superior learning results.

Today there are a variety of mathematical dominoes in the market that work on different topics, such as: division, addition, subtraction, fractionals, among other topics. However, the Math Game and Method of the present disclosure consists of well-designed game methodological rules, which combine the rules of the traditional game of dominoes and the solution of each one of the operations that are placed on the game board, this is done while passing a small acrylic game board to each player in turn, to explain their operations and concepts. In this way, the repetitive action of solving the operations proposed in each game turn, allows the players to internalize the concept that they intend to record.

Additionally, the placement of the equivalent value of the chip in the left upper and lower ends invigorates the game, allowing the participants to become more oriented to the Math Game and Method of the present disclosure and to assist them in following the basic principles of traditional dominoes. (See FIG. 6).

In the Math Game and Method of the present disclosure, the points that appear in the traditional domino are replaced by operations or concepts of the numerical sciences that give as a result the number of points that they replace. The result of these operations is located in the upper and lower left corner of each card, in order that the player can be guided in the sequence of the Math Game and Method of the present disclosure and its rules. The main objective is for each player to solve and explain the operations that the Math Game and Method of the present disclosure poses, on a small acrylic board that will circulate each time the respective turn arrives.

In FIGS. 6 and 7, the equivalences of the traditional dominoes are illustrated, compared to the Math Game and Method of the present disclosure.

In FIGS. 6 and 7, the equivalences of the traditional dominoes are illustrated, compared to the Math Game and Method of the present disclosure

### SUMMARY OF THE DISCLOSURE

The Math Game and Method of the present disclosure is a playful tool that allows students to interact from the beginning of the game to the end, in a carefree way and without pressure to obtain an academic grade. During the development of the game and with the repetition of each explanation of the operations outlined In each card, the student takes confidence in the handling of the proposed topics, allowing him to express himself and act naturally.

The strategies proposed in the instructions for the development of the game, guarantee that the students will record the basic concepts, since the same concept is repeated in a game more than three or four times through different operations. The rules are leading the participants of the game to solve each turn in turn, in such a way that the participants listen to all the explanations of the academic subjects that they want to strengthen and assimilate.

Here verbal communication plays an important role since the student must not only know how to solve the operation set out in the game card that corresponds to him in his turn, but must find the words and the appropriate methodology to explain them to his classmates.

The systematic and repetitive use of this tool for health, the genres of independence in students and the liberations of the pressure of knowledge, the development of the game, the propitious spaces for verbal communication, social interaction, learning, fun and cooperation, determining in the increase of the self-confidence of the student.

It is a practical practice and study that allows the student to enter the concept through the game to reinforce the topic with a reading, review of interactive videos, the solution and practice of other exercises and the explanation of knowledge

Once the student fixes the concept, it can go deeper into the topics of greater complexity and problems of science.

### BRIEF DESCRIPTION OF THE DRAWINGS

FIG. 1 is a schematic view of a Front face of the card according to one representative embodiment of the sheet where operations and results are written for the Math Game and Method of the present disclosure and its equivalent in the traditional domino of the present disclosure;

FIG. 2 is a schematic view of a smooth back side of the sheet without any figures of the present disclosure;

FIG. 3 is a schematic view of Side face of the card end forms of the body of the sheet thickness of about 10 mm of the present disclosure;

FIG. 4 is a schematic view of a Superior face of a tab of the present disclosure;

FIG. 5 is a schematic view of the Inferior face of tab of the present disclosure;

FIG. 6 is a schematic view of the distribution of the front face of the card Space where operations and their results are written of the present disclosure;

FIG. 7 is a schematic view of a traditional domino file of the present disclosure;

FIG. 8 is a schematic view of a Tab of the Level 3 Math Game and Method of the present disclosure. Notable products and algebraic fractions of the present disclosure;

FIG. 9 is a schematic view of a Level 6 Math Game and Method of the present disclosure tab Illustrating the limits and derivatives of the present disclosure.

These and other features of the subject disclosure will become more readily apparent to those having ordinary skill in the art from the following detailed description of the representative embodiments.

### DETAILED DESCRIPTION OF REPRESENTATIVE EMBODIMENTS

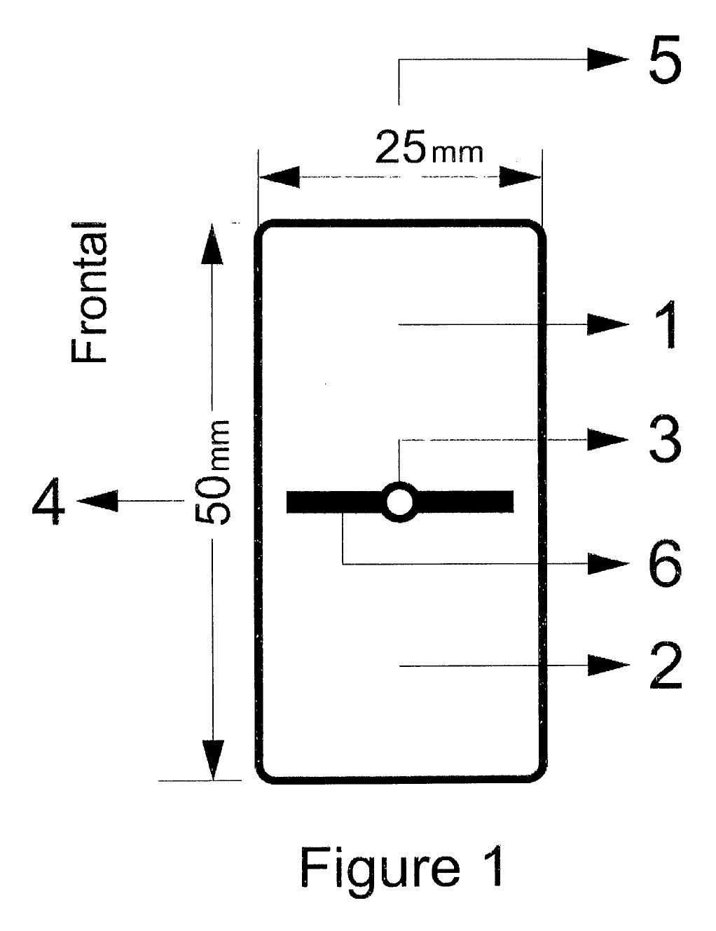

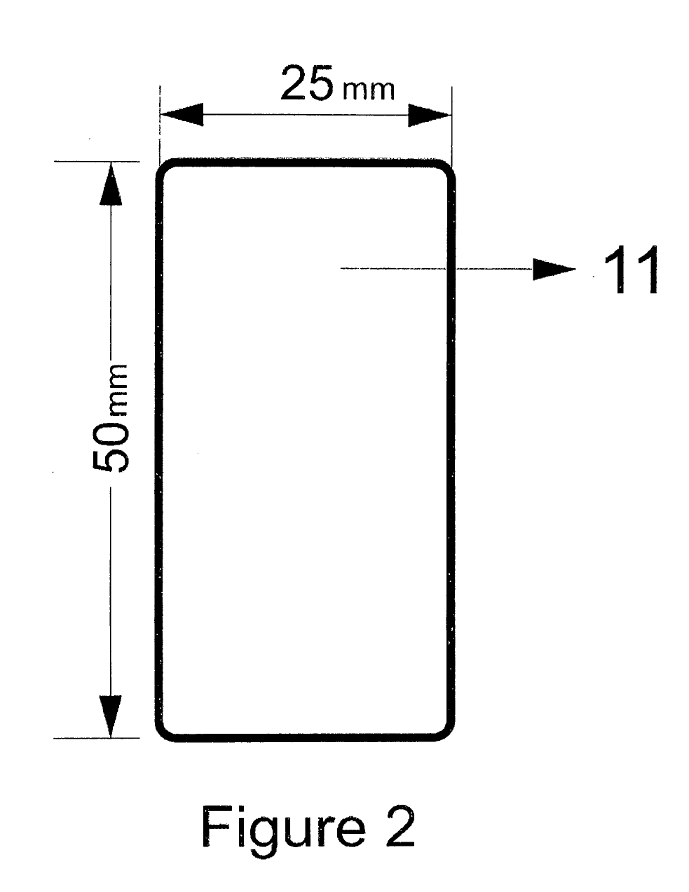

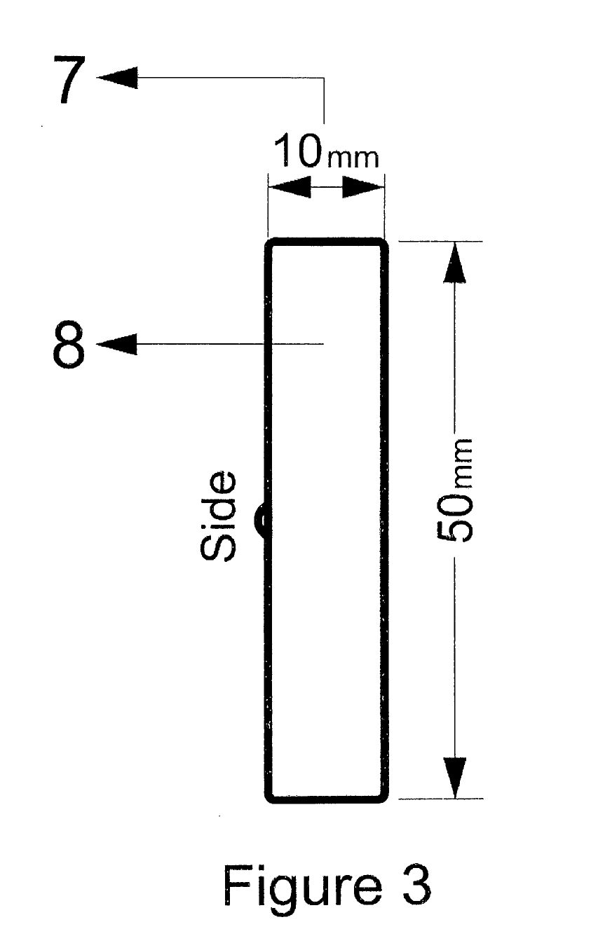

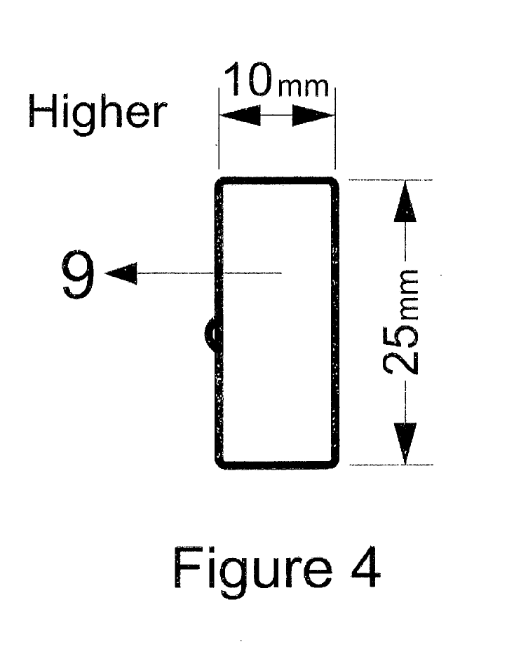

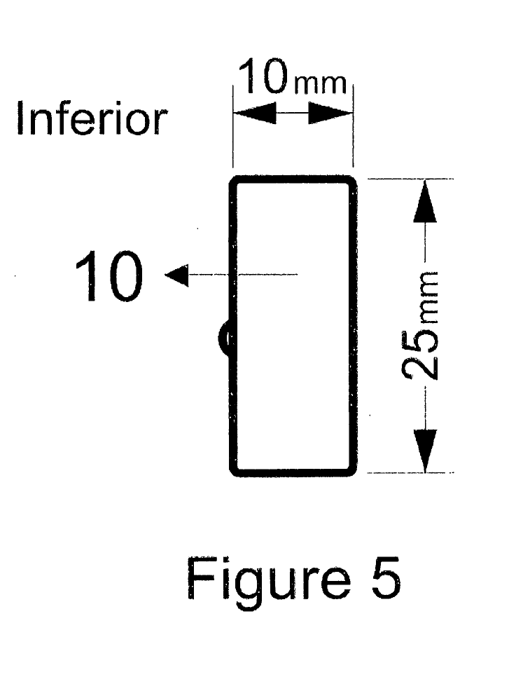

To have a better interpretation of the invention, we refer to FIGS. 1-9. The Math Game and Method of the present disclosure, consists of 28 cards, which have a polyhedral rectangular configuration with dimensions of 50 mm of Height 4, width of 25 mm (5), and thickness of 10 mm (7).

Each token tab is segmented into an upper part 9 and a lower part 10, two side faces 8.

The front face has an upper space 1 and a lower space 2, separated by a dividing line 6, where the operations that are to be solved by the players are written.

Each tile consists of a metallic point 3 that serves as a support for the turn of the tile when it meets the back face 11 up, to be revoked at the start of each game.

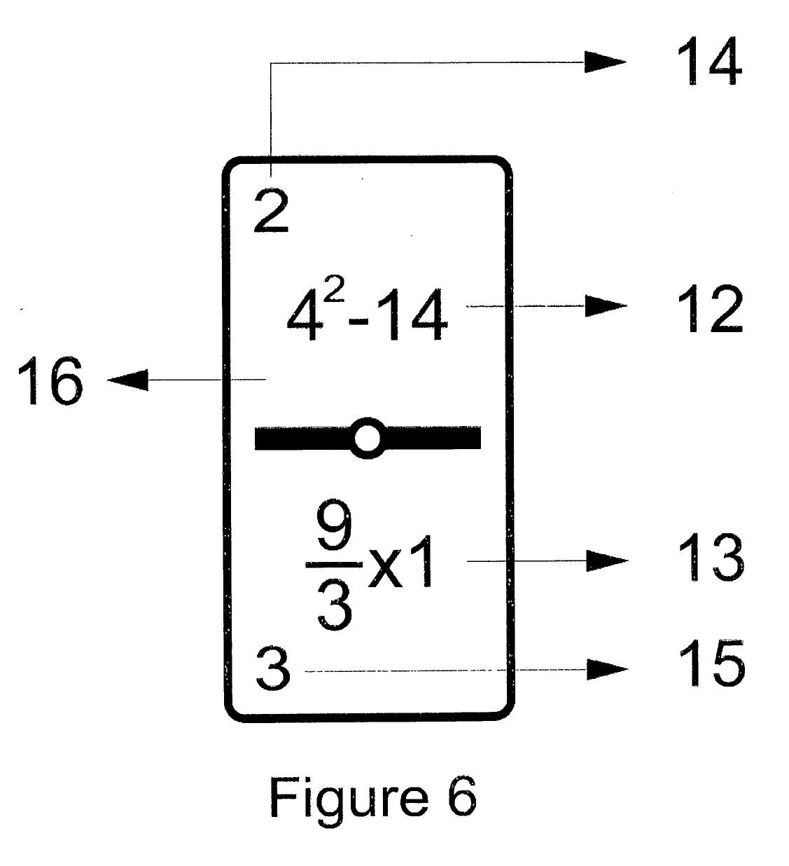

In FIG. 6, a mathematical operation 12 is observed in the upper space 1, whose result 14 is located in the upper left corner, and an operation 13 in the lower space 2, whose result 15 is in the lower left corner of the front face of the card.

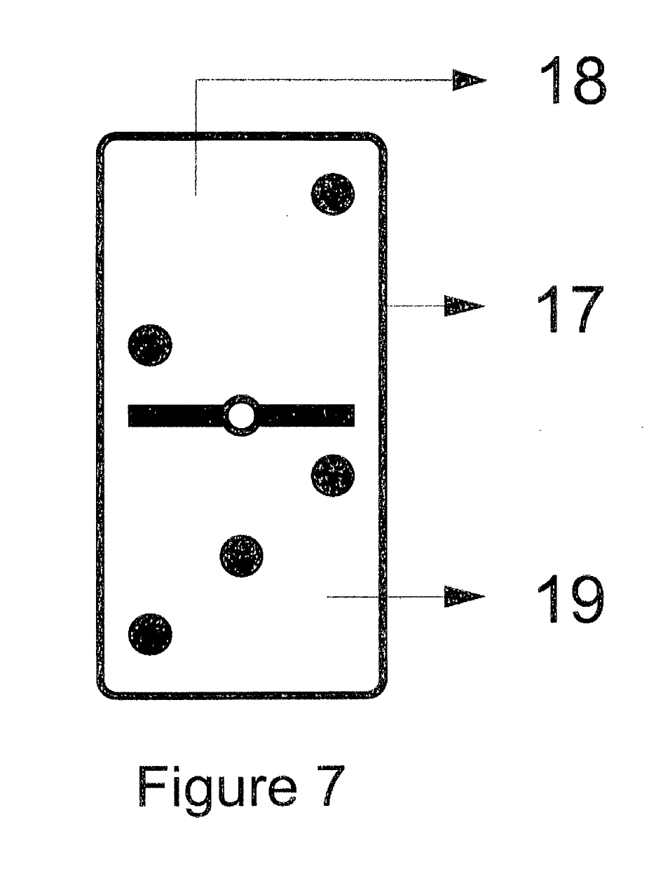

FIG. 7 corresponds to the traditional domino to the card (2, 3), has an equivalent card in the Math Game and Method of the present disclosure 16 The result 14 of the mathematical operation 12 coincides with the number of points 18 of the card 17 of the traditional domino. Likewise, the result 15 of the mathematical operation 13 coincides with the number of point 19 of the card 17.

In the Math Game and Method of the present disclosure, the points that appear in the traditional domino are replaced by operations or concepts of the numerical sciences that give as a result the number of points that they replace. The result of these operations is located in the upper and lower left corner of each card, in order that the player can be guided in the sequence of the game and its rules. The main objective is for each player to solve and explain the operations that the game poses, on a small acrylic board that will circulate each time the respective turn arrives.

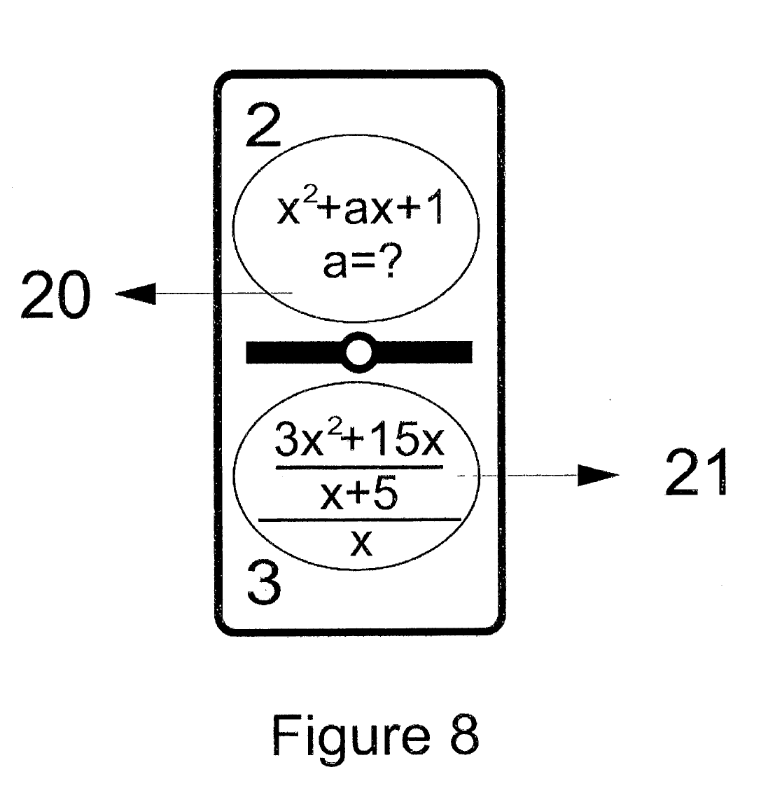

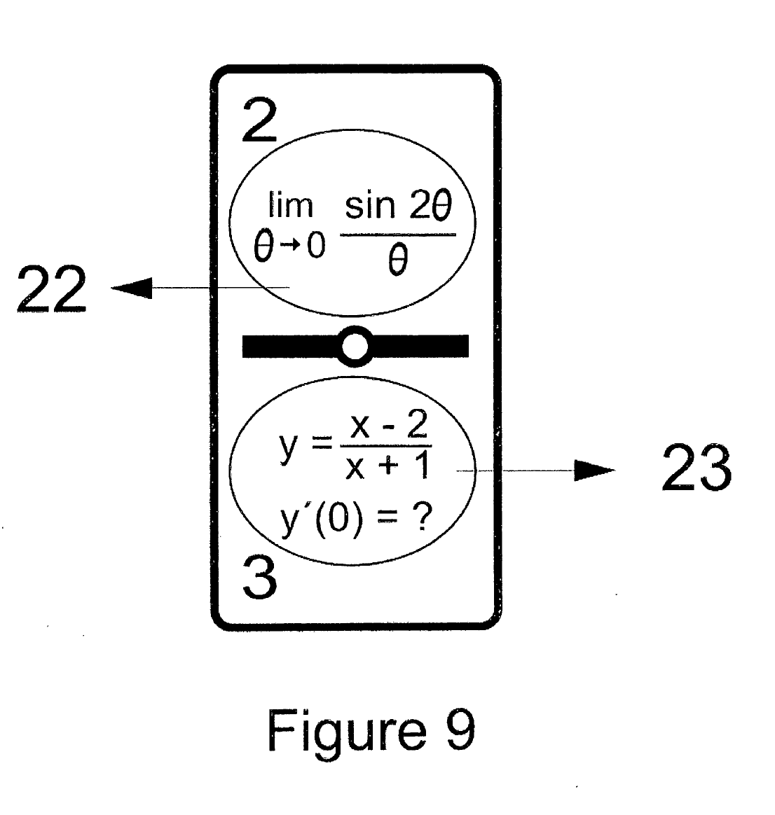

There are several levels of game each of 28 chips. Each level contains different operations according to the level of schooling. The FIG. 6 shows operations that correspond to level 1, which include enhancement and rebates. In FIG. 8, we observe operations with notable products 20 and operations with algebraic fractions 21. In FIG. 9, we see a level 6 file that includes operations of limits 22 and derivatives 23. This level also contemplates other topics.

The Math Game and Method of the present disclosure follows the rules of the traditional domino and includes placing 28 tiles on a game board, each chip with its similar pair. The Math Game and Method of the present disclosure is completed when one of the participants of the game manages to place the last of the chips with which the game started, or when the game is closed because they are unable to fit more chips in the game. In our game the 28 chips are placed on the table, they are stirred and seven (7) chips are distributed to each player.

Below are the rules of the game:

### Rules for Math Game and Method

1. The player designated as the first player, starts the game with twice as many. This player does not respond to any of the two remaining operations on the game board, and immediately the player on his right continues on the turn.

2. The next player (which is to the right of the player who starts the game), decides which of the two operations that are on the game board will solve. In addition, you must solve the operation of the card that you place on the table, which fits in the game. Each player must resolve, if possible, two operations in each game turn. You will have one minute to solve the two operations, which will be counted with a timer or hourglass and will start once the card is placed on the game board. The time must be controlled by any of the players in a visible way

3. Before the game continues, the next player in the turn will have the option to solve and explain some previously unresolved operation and accumulate a point in his favor (for each operation solved). If this player does not solve the operation either, the next player will have the opportunity and so on until reaching the player who placed the chip. If none of the players can solve the operation, it will remain as a task to consult with a teacher, tutor or investigate it at the end of the game.

4. Player #3 who follows the turn will decide to solve and explain any of the operations that appear open at the table, and then must solve and explain the operation placed on the table that fits the operation decided to resolve. If you have difficulties in solving the operation (s), proceed as indicated in step 3.

5. Player #4 will continue the game as player #3 did and so on the innings will continue until the game ends.

6. The first player to get rid of all the chips announces: “I won,” wins the game.

7. If neither can play, the game ends blocked. When this happens, all players turn their chips and add the points of each chip. The player with the lowest score wins the game and gets the points of all the chips of his opponents. The player, who first reaches the number of points agreed at the beginning of the game, wins.

8. At the end of each game, the points of the chips of the players who lost will be totalized. The chosen game modality, alone or in pairs, must be taken into account in order to totalize the points.

9. During the start of a game agreed to an agreed number of points, the player who has the chip six and six (double 6) has the start, however, from now on and until the agreed points are completed, the exit of each game is guaranteed by the winners of the partial games.

10. The game modalities can be:

A. Solo: Each player plays only the game and at the end, who wins the game, takes the chips of their teammates and add the points, accumulating them to reach in one or several games, the number of points agreed at the beginning of the game. (They can be 50 points or those who decide in consensus).

B. In Pair: Players at opposite ends are starting partners. These partners play by supporting each other during the game and interpreting their games. If one of the two teammates wins the game, the other two players take the chips and add the points, accumulating them until reaching in one or several games, the number of points agreed at the start of the game.

11. It must be taken into account that at the end of a game not only the winner or the winners of said game accumulate points, but also those players who had the opportunity to solve additional operations to those of their turn.

The goal of the game is to learn by listening to the successive explanations of the playmates and to fix and internalize the concepts that are exposed, so that in a next opportunity, the student can already answer and assimilate the topics in which before he or she had shortcomings.

### 5 Phases of Math Learning

### Ideas Stimulator

The goal of the game is to learn by listening to the successive explanations of the playmates and to fix and internalize the concepts that are exposed, so that in a next opportunity the student can already answer and assimilate the topics in which before I had shortcomings.

The combination of recreational activities with the learning of the numerical sciences, structure the logical thinking of the individual who uses them, allowing him/her to participate, create, construct, assimilate, explore and structure essential mental processes in the intellectual strengthening.

The combination of recreational activities with the learning of the numerical sciences, structure the logical thinking of the individual who uses them, allowing him/her to participate, create, construct, assimilate, explore and structure essential mental processes in the intellectual strengthening.

This playful tool, by the mental activity that it carries out, generates a starting point for the teaching of mathematics, and creates the basis for a later formalization of mathematical thought.

The learning and mastery of the mathematical sciences, endow individuals with a set of instruments that enhance and enrich their mental structures, and enable them to explore and act in reality. The games teach schoolchildren to take the first steps in the development of intellectual techniques, enhance logical thinking, develop reasoning habits, teach thinking with a critical spirit.

Awakening the logical mathematical intelligence has to do with the ability to work and think in terms of numbers and the ability to use logical reasoning.

However, this type of intelligence brings us important benefits, such as the ability to understand concepts and establish relations based on logic in a schematic and technical way. It implies the ability to use the calculation, quantifications, propositions or hypotheses almost naturally.

Next to the intellectual development of the student is the development of inventive and creative processes, intuitive ability and argumentation.

### Interaction Generator

The playful activities allow the free development of the personality and emotions, in the spaces in which the individual socializes and interacts with his playmates.

The assimilation and understanding of essential academic processes, subsequently allow the individual to understand physical, chemical, biological phenomena, among others, of the environment with which it interacts.

The social interactions between classmates, students and teachers, members of a family, communities of other schools or friends of the neighborhood, are an essential feature in the use of this playful tool.

The games and materials encourage us and push us to touch, manipulate, visualize, reason, that is, to get involved and therefore to learn what needs to be learned in order to advance in our objective, which may be solving a challenge or winning a game.

In addition, when apprenticeships are acquired through retention, they are more durable in the medium-long term, that is, we remember them longer. The main reason for this durability is that by getting more involved, the interface between learning and our body and mind is greater and therefore memory is activated in different ways. We remember more and better because seeing, touching, hearing and feeling the imprint that leaves us is deeper.

### Interaction Generator

The playful activities allow the free development of the personality and emotions, in the spaces in which the individual socializes and interacts with his playmates.

The assimilation and understanding of essential academic processes, subsequently allow the individual to understand physical, chemical, biological phenomena, among others, of the environment with which it interacts.

The social interactions between classmates, students and teachers, members of a family, communities of other schools or friends of the neighborhood, are an essential feature in the use of this playful tool.

The games and materials encourage us and push us to touch, manipulate, visualize, reason, that is, to get involved and therefore to learn what needs to be learned in order to advance in our objective, which may be solving a challenge or winning a game.

The games and materials encourage us and push us to touch, manipulate, visualize, reason, that is, to get involved and therefore to learn what needs to be learned in order to advance in our objective, which may be solving a challenge or winning a game.

In addition, when apprenticeships are acquired through retention, they are more durable in the medium-long term, that is, we remember them longer. The main reason for this durability is that by getting more involved, the interface between learning and our body and mind is greater and therefore memory is activated in different ways. We remember more and better because seeing, touching, hearing and feeling the imprint that leaves us is deeper.

### Practical Method of Studying

Once the teacher has raised and explained the basic topics included in their school academic program, students can begin to play without the supervision of the teacher or the teacher's participation in the game, unless the students initially request it in the school adaptation process.

The systematic and repeated use of this playful tool generates independence in the students and frees them from the pressure of the teacher, since during the development of the game, spaces are provided where verbal communication, social interaction, learning, fun and cooperation, are decisive in increasing the self-confidence of the student.

The systematic and repeated use of this playful tool generates independence in the students and frees them from the pressure of the teacher, since during the development of the game, spaces are provided where verbal communication, social interaction, learning, fun and cooperation, are decisive in increasing the self-confidence of the student.

It is a practical and methodical way of studying as the student is introduced to the concept through the game to reinforce later the topic with a reading, the review of interactive videos, the solution and practice of other exercises and the explanation of the teacher.

Once the student fixes the concept, it can go deeper into topics of greater complexity and problems of application of the sciences. This type of activities has a productive character where the student must generate their own reasoning based on initial basic instructions. In these spaces of participatory play, a creative climate is generated for the teaching-learning process using a communication system that facilitates and mobilizes creativity and focuses on the needs and possibilities of the student.

### Increase Learning

The strategies outlined in the instructions for the development of the game guarantee that the students will record the basic concepts, since the same concept is repeated in a game, more than three or four times through different operations. The rules are leading the participants of the game to solve each turn in turn, in such a way that the participants listen to all the explanations of the academic subjects that they want to strengthen and assimilate.

Here verbal communication plays an important role since the student must not only know how to solve the operation set out in the game card that corresponds to him in his turn, but must find the words and the appropriate methodology to explain them to his classmates.

The participation of the student becomes more active, since in each game turn he must explain the operations that correspond to him, in addition he must find the most appropriate and convenient way to make himself understood in his small exhibitions of one minute.

The game mechanism raises throughout its development, the student is careful to listen to all the explanations of their fellow players, to understand and respond to all proposed operations. It is precisely this degree of attention that allows an increase in the apprehension of knowledge, and the improvement in academic performance.

### Fosters Healthy Fun

Surely the best way to awaken a student is to offer an intriguing game, a joke, a paradox, a magic trick mixed with the mathematical nature, or any other activity that some traditional and orthodox teachers tend to avoid because they seem boring or loss of time.

This playful tool allows students to interact from the beginning of the game to the end, in an unsuspecting way and without pressure for obtaining an academic grade.

During the development of the game and with the repetition of each explanation of the operations outlined in each card, the student will take confidence and management in the proposed topics, allowing him to express himself and act naturally.

The promotion of self-confidence is a fundamental element for the integral development of students that is why as students begin to dominate academic topics, they feel more motivated, have more fun and compete with strategies to overcome their peers of departure.

Although the present disclosure has been described and illustrated with respect to example embodiments, it is apparent that modifications and changes can be made thereto without departing from the spirit and scope of the presently disclosed fluid filter assembly and anti-drip element as defined in the following claims.

What is claimed is:

1. A mathematical dominos game comprising:
a plurality of domino shaped game pieces;
each domino shaped game piece being segmented into an upper portion and a lower portion; the upper portion overlaying and being operatively connected to the lower portion;
the upper portion and lower portion having a face divided into a left section and a right section below;
the left section and the right section each having a numerical indicia means incorporated thereupon wherein the user selects a corresponding mathematical operation; and
the corresponding mathematical operation consisting of a physical representation of addition, subtraction, division, multiplication, equality, calculus operations, comparison, and algebraic equations wherein the numerical indicia on the left section, the mathematical operation and the numerical indicia on the right section in combination formulates a means for computing a mathematical equation by a user.

2. A method of playing a dominos-style mathematical operation game comprising the steps of:
providing a plurality of rectangular shaped dominos each having a pair of longer side edges and a pair of shorter end edges, and a top face and a bottom face, the bottom face of each domino having a pair of equally sized end sections, each end section having a unique combination of a number indicia and a pair of contrasting mathematical signs chosen from the groups of a physical representation of addition, subtraction, division, multiplication, equality, calculus operations, comparison, and algebraic equations, one of the contrasting signs being operatively positioned on one of the end sections and the other one of the contrasting signs being operatively positioned on the other end section;
placing the end edges of two of the dominos in contiguous relationship such that the mathematical signs of the end sections of the contiguous dominos match; and
awarding a number of points generated by way of operating on numbers represented by the number indicia of the contiguous sides as a function of the mathematical sign.

3. A method of playing a mathematical dominos game comprising the steps of:
providing a plurality of dominos shaped cards, each domino shaped card having a top face and a bottom face, each face being divided into a left side having an indicia and a right side having an indicia with a mathematical operation operatively positioned between the left side and the right side,
prior to initiating the mathematical dominos game, each player randomly selects a predetermined numerical factor;
providing each player with a corresponding hand of a predetermined subset of the dominos shaped cards with a remaining portion of the dominos shaped cards comprising a deck of non-active domino shaped cards;
for the current player, selecting a domino shaped card from its hand to become an active card within an active deck of domino shaped cards defined by a plurality of adjacently aligned domino shaped cards based upon a corresponding adjacent numerical base;
aligning the selected shaped domino card with a numerical base of an exposed side of a domino shaped card within the active deck;
if the current player has no matching active domino shaped card within its hand, then go to allowing the current player to pull a domino shaped card from the deck of non-active domino shaped cards until a domino card is pulled that matches the numerical base of an exposed side within the active deck;
simultaneously, the player selecting a mathematical operation on the domino shaped card and selecting a mathematical operation that formulates a mathematical equation using the numerical indicia means on the left side, the numerical indicia means on the right side and the selected mathematical operation that provides the current player with the most points based upon the exposed side of the domino shaped card;
determining the current player total points by summing clock wise each of the most points on the exposed side of each shaped domino card of the active deck;
determining the current player total points.
